(19) United States
(12) Patent Application Publication
(10) Pub. No.: US 2016/0379447 A1
(43) Pub. Date: Dec. 29, 2016

(54) MANAGEMENT SYSTEM, MANAGEMENT DEVICE, AND NON-TRANSITORY RECORDING MEDIUM

(71) Applicant: Konami Digital Entertainment Co., Ltd., Tokyo (JP)

(72) Inventors: Sadaaki Kaneyoshi, Minato-ku (JP); Masato Okuaki, Minato-ku (JP)

(21) Appl. No.: 15/263,181

(22) Filed: Sep. 12, 2016

Related U.S. Application Data
(63) Continuation-in-part of application No. PCT/JP2015/053651, filed on Feb. 10, 2015.

(30) Foreign Application Priority Data
Mar. 13, 2014 (JP) 2014-050668

(51) Int. Cl. G07F 17/32

(52) U.S. Cl. CPC G07F 17/3258; G07F 17/3272; G07F 17/323; G07F 17/3262

(57) ABSTRACT

A management system comprises: at least one gaming machine; a jackpot controller that increases a progressive jackpot value according to a betting operation by a player on the at least one gaming machine and determines a winner of a progressive jackpot for the at least one gaming machine; and a management device that is communicably connected to the at least one gaming machine with each other and conducts bonus processing for a predetermined bonus by using identification information of the player on the gaming machine of the at least one gaming machine based on at least the progressive jackpot value being within a predetermined range.

### CROSS-REFERENCE TO RELATED APPLICATION

This application is a continuation-in-part of International Application No. PCT/JP2015/053651, filed Feb. 10, 2015. Note that this application claims the benefit of priority from Japanese Patent Application No. 2014-050668, filed Mar. 13, 2014, and the entire content of the basic applications are incorporated herein.

### TECHNICAL FIELD

The present disclosure relates to a management system, a management device, and a non-transitory recording medium.

### BACKGROUND ART

A conventional jackpot system is known which includes at least one gaming machine and a jackpot controller. As a type of jackpot game, there is known a progressive jackpot game in which the jackpot value increases with the amount of bet placed by a player on a gaming machine.

### CITATION LIST

### Patent Literature

Patent Literature 1: Japanese Unexamined Patent Publication No. 2009-72589.

### SUMMARY OF INVENTION

### Technical Problem

When the jackpot value increases in a gaming machine, many players are motivated to play on the gaming machine, expecting a large amount of profit. This raises the operating rate of the gaming machine to a relatively high level. On the contrary, when the jackpot value is close to the initial value, player's expectation for the profit is relatively low, which decreases the operating rate of the gaming machine to a relatively low level. In other words, the operating rate of the gaming machine fluctuates with the jackpot value.

In this technical field, a management system has been required which can suppress the fluctuations of the operating rate of the gaming machine.

### Solution to Problem

A management system according to one aspect of the present disclosure comprises: a jackpot controller that increases the progressive jackpot value according to a betting operation by a player on at least one gaming machine and determines the winner of the progressive jackpot for the at least one gaming machine; and a management device that is communicably connected to the at least one gaming machine with each other and conducts bonus processing for a predetermined bonus by using the identification information of a player on the gaming machine of the at least one gaming machine based on at least the progressive jackpot value being within a predetermined range.

\A management device according to one aspect of the present disclosure comprises: a receiver that receives a progressive jackpot value increasing according to a betting operation by a player on at least one gaming machine and being controlled by a jackpot controller; and a bonus processor that conducts bonus processing for a predetermined bonus by using the identification information of a player on the gaming machine of the at least one gaming machine based on at least the progressive jackpot value being within a predetermined range.

A non-transitory recording medium storing a program according to one aspect of the present disclosure makes a computer function as: a receiver receiving a progressive jackpot value increasing according to a betting operation by a player on at least one gaming machine and being controlled by a jackpot controller; and a bonus processor conducting bonus processing for a predetermined bonus by using the identification information of a player on the gaming machine of the at least one gaming machine based on at least the progressive jackpot value being within a predetermined range.

### BRIEF DESCRIPTION OF DRAWINGS

FIG. 1 is block diagram of a management system according to an embodiment.

FIG. 2 is a block diagram illustrating functional components of a casino management server in FIG. 1.

FIG. 3 illustrates a configuration of a database stored in the casino management server in FIG. 1.

FIG. 4 illustrates a process flow according to an embodiment.

FIG. 5 illustrates the initial value, threshold, and upper limit value of a jackpot value.

### DESCRIPTION OF EMBODIMENTS

Embodiments of the present disclosure will now be described with reference to the attached drawings. It should be noted that common components in the drawings are denoted by the same reference sign and their description will not be repeated.

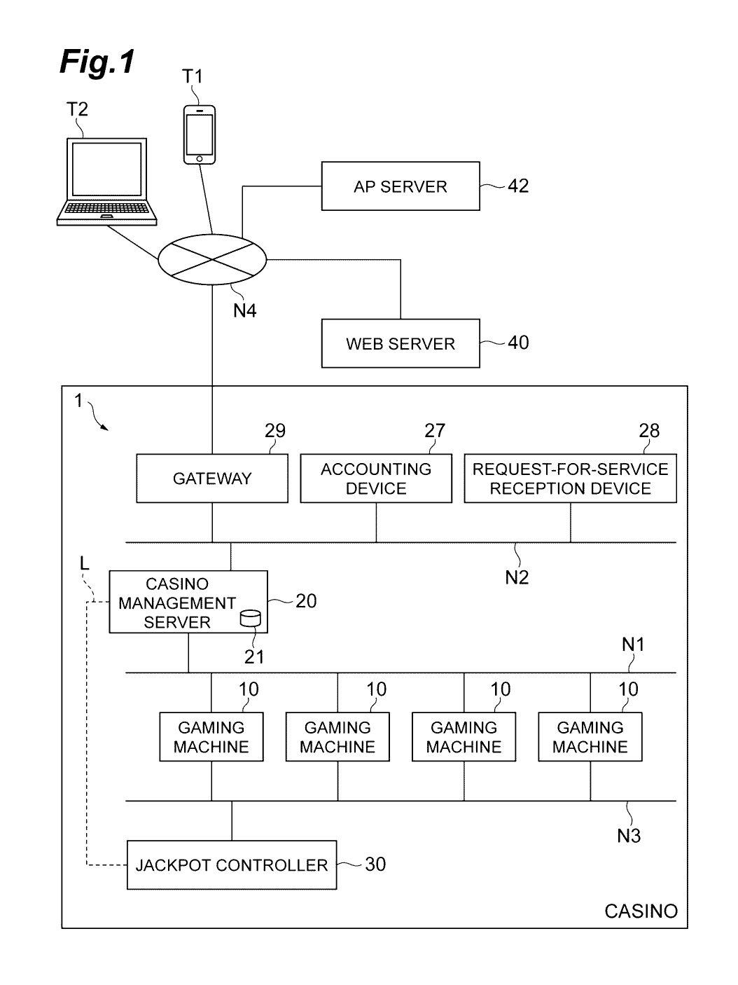

FIG. 1 is a block diagram of a management system 1 according to an embodiment. The management system 1 is installed in a casino. In this description, a casino refers to a complex facility containing a casino floor installed with gaming machines, and additional facilities, such as restaurants, hotels, and theaters.

As shown in FIG. 1, the management system 1 includes a plurality of gaming machines 10, a casino management server 20, and a jackpot controller 30.

Each gaming machine 10, which is installed on the casino floor in the casino, is a video slot machine, for example. Each gaming machine 10 may be a slot machine, a poker machine, or a roulette machine including mechanical reels, or any other video gaming machine or mechanical gaming machine. Unique authentication data, namely machine ID is allocated to each gaming machine 10. It should be noted that, although FIG. 1 illustrates four gaming machines 10, the number of gaming machines 10 is changeable depending on the situation and therefore may be even one.

Each gaming machine 10 has a card reader not shown in the drawing. The card reader acquires information on a player from the ID card of the player. This ID card, which is also called “house card”, can be used as a membership card in the casino. Guests in the casino have such ID cards issued after the registration of personal information. For instance, a guest applies for ID issuance in advance and then registers his name, address, E-mail address and other personal information to get an ID card in return. The ID card has authentication data, namely customer ID unique to each person. The customer ID is stored, for example, in the IC chip, bar code, or magnetic tape on the ID card. It should be noted that personal information given at the acquisition of the ID card is stored, being associated with the customer ID, in a database 21 in the casino management server 20 described later.

When a player lets the card reader of the gaming machine 10 read his ID card, the gaming machine 10 acquires the customer ID of the player and various information associated with the customer ID and stored in the database 21 in the casino management server 20.

The casino management server 20 is device that acquires various data in the casino for central management of the information in the casino. The casino management server 20 is installed, for example, in a room for heavy security of the casino, i.e., a security room. The security room is restricted and the guests of the casino are therefore not allowed to enter this room. For instance, only the general manager of the casino is allowed to enter the security room.

The casino management server 20 is connected to each gaming machine 10 via an internal network N1 so as to communicate with each other. Specifically, each gaming machine 10 has a terminal box for communication with the casino management server 20. This terminal box allows for communication with the casino management server 20. It should be noted that the casino management server 20 communicates not only with the above-described gaming machines 10 but with any other gaming machine installed in the casino.

The casino management server 20 is connected not only to the gaming machines in the casino but to any other terminals in the casino so as to communicate with each other. For instance, as shown in FIG. 1, the casino management server 20 is connected to an accounting device 27 and a request-for-service reception device 28 via an internal network N2 so as to communicate with each other.

The accounting device 27 is, for example, an accounting terminal in a casher or a kiosk terminal on the casino floor, an accounting terminal at the reception counter of a hotel in the casino, or an accounting terminal in a restaurant in the casino. Similarly to each gaming machine 10, the accounting device 27 has a card reader through which it can read the customer ID from the guest's ID card.

The request-for-service reception device 24 is, for example, a system for booking a hotel in the casino or a reception system for booking theater tickets. Similarly to each gaming machine 10, the request-for-service reception device 24 has a card reader through which it can read the customer ID from the guest's ID card.

Accordingly, the casino management server 20 achieves central management of guest's information through customer IDs, thereby revealing all the contents and prices of services offered to the guests in the casino.

The jackpot controller 30 is installed on the casino floor or in the security room. The jackpot controller 30 is connected to each gaming machine 10, not via the internal network N1 but via an internal network N3.

The jackpot controller 30 provides the gaming machines 10 with a progressive jackpot. In particular, the jackpot controller 30 accumulates jackpot values according to a betting operation in each gaming machine 10. For example, the jackpot controller 30 receives the amount of bet placed for the game on each gaming machine 10 and adds the received amount of bet to the jackpot value at a constant ratio. Alternatively, the jackpot controller 30 may add a value dependent on that amount of bet to the jackpot value only if the amount of bet placed for one game reaches a predetermined amount.

The jackpot controller 30 determines the winner of the progressive jackpot for the plurality of gaming machines 10. Specifically, upon reception of information on the bet from one gaming machine 10, the jackpot controller 30 determines whether that gaming machine 10 wins the jackpot or not and sends the determination to the gaming machine 10. It should be noted that this determination of the winner may be performed only when a predetermined amount or more of bet is placed on any gaming machine 10.

The winner of the jackpot may be determined under a lottery system using a random number upon each reception of information on the bet placed on any gaming machine 10. Alternatively, a winning timing may be determined in advance (e.g., upon start of the accumulation of jackpot values) under a lottery system. The winning timing may be determined based on, for example, the jackpot value at which the jackpot is won, the date and time when the jackpot is won, the order in which the jackpot is won on the gaming machines after the start of the accumulation.

The jackpot controller 30 sends the jackpot value to the gaming machine 10 and always displays the latest jackpot value on the display of the gaming machine 10. The jackpot controller 30 also sends the jackpot value to the casino management server 20 and causes the casino management server 20 to always retain the latest jackpot value. The jackpot controller 30 sends the jackpot value in a predetermined cycle and timing (e.g., the timing of update of the jackpot value of the jackpot controller 30).

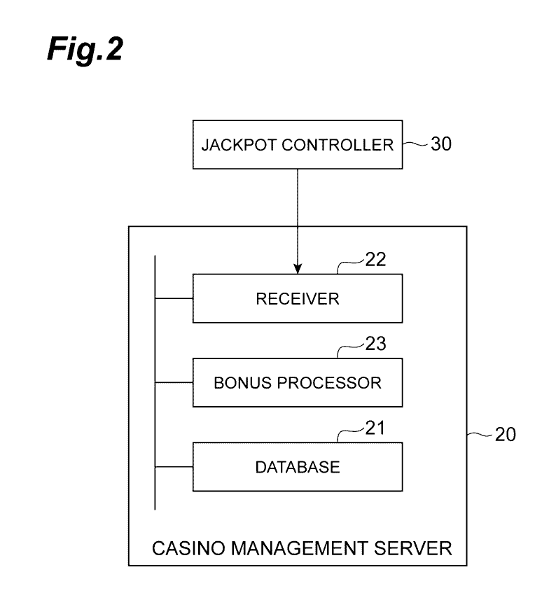

As shown in FIG. 2, the casino management server 20 includes, as functional components, a receiver 22 and a bonus processor 23 as well as the database 21. The receiver 22 receives the jackpot value from the jackpot controller 30 directly or indirectly, i.e., via the gaming machine 10. The bonus processor 23 performs bonus processing for a bonus described later, if the jackpot value is within a predetermined range.

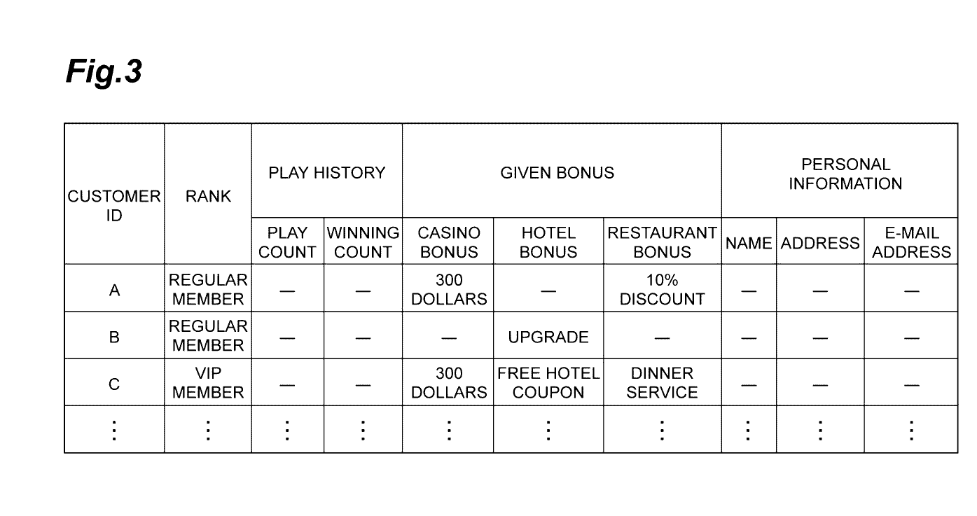

The casino management server 20 includes the database 21. The database 21 includes a mass-storage device, such as a hard disc drive or a semiconductor memory. As shown in FIG. 3, the database 21 contains attribute information, such as a rank, a play history, given bonuses, and personal information, associated with the customer ID.

The rank is a type of grouping information for classifying the guests of the casino and is allocated based on the play history, for example. A “regular member” is a member registered to the casino and his total bet spent in the casino during a predetermined period (e.g., during the past month) is not more than a threshold. A “VIP member” is a member registered to the casino and his total bet spent in the casino during a predetermined period (e.g., during the past month) is above the threshold. The operator of the casino distinguishes “regular members” and “VIP members” and differentiates services offered to “regular members” and “VIP members” to give grant treatment to “VIP members”. The rank may also be determined, for example, by whether the member plays the game with a frequency at or above a predetermined level or whether the member has downloaded an application (described later) on his communication terminal.

The play history may contain the play count, i.e., the total number of times that the member played the game on the gaming machine 10 during a predetermined period. The play history may also contain the winning count, i.e., the total number of times that the member won the jackpot during a predetermined period. The play history may also contain the model name of the machine that the member played on, the payback percentage, and the total length of time spent on playing games, for example.

The given bonus is information associated with the right of the player to get a bonus. Bonuses that the player can get will now be explained referring to the database 21 in FIG. 3.

A customer ID “A” is associated with a bonus of 300 dollars which is a casino bonus that can be offered on the casino floor in the casino. Hence, the card reader of the accounting device 27 reads the customer ID “A” in the ID card and refers to the database 21 of the casino management server 20 to pay out 300 dollars for the player. It should be noted that the kiosk terminal can alternatively pay out 300 dollars upon an input from the customer ID “A”. The payout can be done in cash or equivalent tickets, for example.

The customer ID “A” is also associated with a 10% discount bonus which is a restaurant bonus that can be offered in a restaurant in the casino. Hence, the card reader of the accounting device 27 in the restaurant reads the customer ID “A” in the ID card and refers to the database 21 of the casino management server 20 to accept a 10% discount.

A customer ID “B” is associated with a room upgrade bonus which is a hotel bonus that can be offered in a hotel in the casino. Hence, the card reader of the request-for-service reception device 28 in the hotel reads the customer ID “B” in the ID card and refers to the database 21 of the casino management server 20 to upgrade the player's room.

Similarly to the player identified with the customer ID “A”, a customer ID “C” is associated with a bonus of 300 dollars which is a casino bonus that can be offered on the casino floor in the casino.

The customer ID “C” is further associated with a bonus of a free hotel coupon which is a hotel bonus that can be offered in a hotel in the casino. Hence, the card reader of the request-for-service reception device 28 in the hotel reads the customer ID “C” in the ID card and refers to the database 21 of the casino management server 20 to issue the free hotel coupon.

The customer ID “C” is also associated with a bonus of the right to apply for a dinner service available only for guests having the bonus, which is a restaurant bonus that can be offered in a restaurant in the casino. Hence, the card reader of the request-for-service reception device 28 in the restaurant reads the customer ID “C” in the ID card and refers to the database 21 of the casino management server 20 to receive the application for the dinner service.

As described above, the number of or level of bonuses associated with each customer ID is various and can be uniquely set by each casino.

The personal information includes information given at the acquisition of the ID card, e.g., the name, address, and E-mail address. The personal information may further include the age, occupation, family structure, and social security number.

The casino management server 20 is also connected to a gateway 29 and can communicate with an Internet N4, which is an external network, via the gateway 29.

The casino management server 20 sends a jackpot value stored in the casino management server 20 to a Web server 40 on the Internet N4 via the gateway 29. The Web server 40 provides, as a Web service, information on the jackpot value received from the casino management server 20 to communication terminals T1 and T2 connectable to the Internet N4. The users of the communication terminals T1 and T2 can confirm the real-time jackpot value when they access the Web server 40. The communication terminals are, for example, a portable terminal T1 (e.g., a cellular phone, smartphone, or tablet) and a personal computer T2 (e.g., a laptop PC or desktop PC) illustrated in FIG. 1.

The Web server 40 can also send the jackpot value, which is received from the casino management server 20, to the users of the communication terminals T1 and T2 in the form of E-mail or any message.

An AP server (application server) 42 is also provided on the Internet N4. The AP server 42 conducts a communication for execution of a predetermined application program on the communication terminals T1 and T2. The AP server 42 sends data, which is intended for processing the application, to the communication terminals T1 and T2. For instance, in order to display the jackpot value with the application on the communication terminals T1 and T2, the AP server 42 sends data of the jackpot value to the communication terminals T1 and T2.

If the Web service or application (hereinafter referred to as “external service”) is a game or communication tool that generates data unique to the user, such as play history or message history, at least part of the data unique to the user may be stored on the Web server 40 or the database of the AP server 42. The casino management server 20 can receive the data unique to the user stored on the Web server 40 or the database of the AP server 42 and determine, for example, whether the corresponding player on the gaming machine 10 in the casino has reached a predetermined game score with the external service, whether the player uses the external service with a frequency at or above a predetermined level, and whether the player has confirmed the jackpot value with the external service.

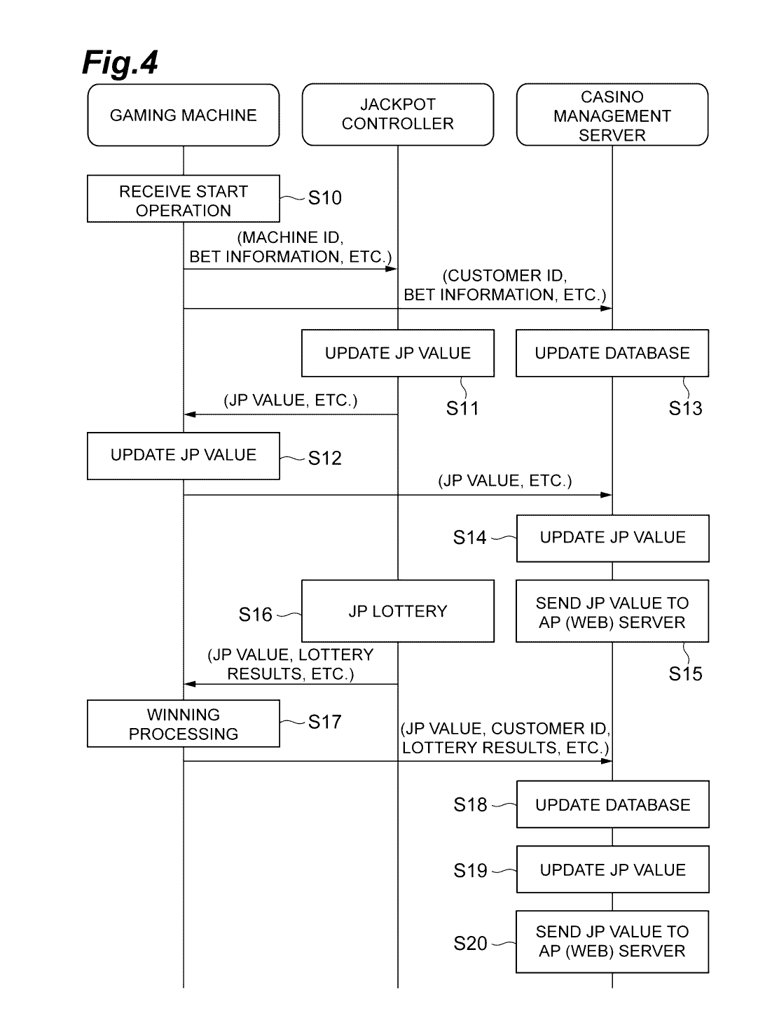

The process flow in the management system 1 will now be explained with reference to FIG. 4.

The player gives an operation to start the gaming machine 10. Specifically, the player lets the card reader of the gaming machine 10 read the information in the ID card of the player and places a bet on the gaming machine 10 to start the game. In response to the start operation by the player, the gaming machine 10 sends bet information including the amount of bet, which information is associated with the machine ID, to the jackpot controller 30 and also sends the bet information, which is associated with the customer ID read from the player's ID card, to the casino management server 20.

Upon reception of the machine ID and the bet information from the gaming machine 10, the jackpot controller 30 adds a value, which is equivalent to the amount of bet included in the bet information, to the jackpot value to update the jackpot value (JP value) as S11. After updating the jackpot value, the jackpot controller 30 sends the updated jackpot value to the gaming machine 10.

Upon reception of the updated jackpot value, the gaming machine 10 updates the jackpot value displayed on a monitor or any other display device as S12 and then sends (transfers) the updated jackpot value to the casino management server 20.

Upon reception of the customer ID and the bet information from the gaming machine 10, the casino management server 20 updates the database 21 as S13. At this time, at least the play history associated with the customer ID is updated.

If the jackpot value at the reception of the customer ID and the bet information is within a predetermined range, the bonus processor 23 in the casino management server 20 modifies the information in the database 21 as bonus processing. Specifically, the bonus processor 23 of the casino management server 20 modifies the information on the given bonus in the database 21 so that the player can get the right to receive a predetermined bonus. The bonus processing in S13 is conducted if the jackpot value at the start of the game is within a predetermined range.

After updating the database 21, the casino management server 20 receives, at the receiver 22, the updated jackpot value from the gaming machine 10, updates the jackpot value to store as S14, and then sends the updated jackpot value to the Web server 40 and the AP server 42. This allows the users of the communication terminals connected to the Internet N4 to check the updated jackpot value on a website or with an application.

Concurrently, after updating the jackpot value and sending it to the gaming machine 10, the jackpot controller 30 determines, under a lottery system, whether the gaming machine 10 from which the jackpot controller 30 received the machine ID wins the jackpot or not, as S16.

Subsequently, the jackpot controller 30 sends the lottery results to the gaming machine 10. It should be noted that, if the jackpot is won, the jackpot value at the time of the winning may be sent to the gaming machine 10 along with the lottery results.

If the gaming machine 10 wins the jackpot value, the gaming machine 10 conducts the predetermined winning processing as S17. The winning processing involves payout of the amount of money equivalent to the jackpot value.

After the winning processing (or before the winning processing), the gaming machine 10 sends the customer ID, which is associated with the lottery results and the jackpot value at the time of the winning, to the casino management server 20.

In the casino management server 20, upon reception of the lottery results and the jackpot value at the time of the winning associated with the customer ID from the gaming machine 10 at the receiver 22, the bonus processor 23 updates the database 21 as bonus processing in S18. Specifically, the casino management server 20 modifies the given bonus in the database 21 so that the player can get the right to receive the above-described bonus. The bonus processing in S18 is conducted if the jackpot value at the time of the winning is within a predetermined range. As S19, the jackpot value is updated to be reset to an initial value.

Afterwards, the casino management server 20 sends the updated jackpot value to the Web server 40 and the AP server 42 as S20 so that the updated jackpot value can be checked on the Web or with an application.

As explained above, in the management system 1, the casino management server 20 associates a predetermined bonus with the identification information of the player on the gaming machine 10 and conducts the bonus processing for the predetermined bonus if the jackpot value is within a predetermined range.

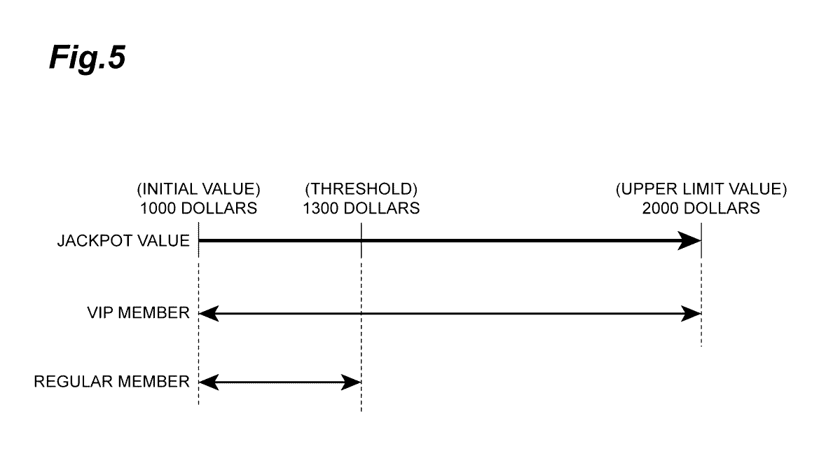

The range of jackpot value within which the bonus processing is conducted is not more than a predetermined threshold, for example. In the case where the initial jackpot value is 1000 dollars and the upper limit jackpot value is 2000 dollars as shown in FIG. 5, the players on the gaming machines 10 are granted the right to receive the above-mentioned bonus when the jackpot value is not more than a threshold of 1300 dollars, for example.

An increase in the jackpot value at that time makes many players, who expect a large amount of profit, want to play on the gaming machines 10 and raises the operating rate of the gaming machines 10 to a relatively high level. On the contrary, when the jackpot value is far from the upper limit value, e.g., close to the initial value, player's expectation for the profit is relatively low, decreasing the operating rate of the gaming machines 10 to a relatively low level.

An increase or decrease in the jackpot value changes player's interest in the gaming machines 10, thus causing fluctuations in the operating rate of the gaming machines.

To avoid it, in the aforementioned management system 1, when the jackpot value is not more than the threshold and the operating rate of the gaming machine 10 is low, the casino management server 20 conducts bonus processing so that the players on the gaming machines 10 can get the right to receive a predetermined bonus, which motivates the guests to play on the gaming machines 10. This leads to an increase in the operating rate of the gaming machines 10, resulting in less fluctuation in the operating rate of the gaming machines 10. It should be noted that the aforementioned threshold can be varied according to the player's rank (regular member or VIP member). In particular, a regular member can be granted the right to receive a bonus when the jackpot value is not more than a threshold of 1300 dollars, while a VIP member can be granted the right to receive a bonus when the jackpot value is not more than a threshold of 1700 dollars. Alternatively, a plurality of thresholds can be used. When a plurality of thresholds is used, different thresholds may be related to different contents, types, or levels of bonus to be given.

It should be noted that the casino management server 20 may conduct the aforementioned bonus processing if the jackpot value is within a predetermined range and a predetermined play condition related to the player on the gaming machine 10 is satisfied. Examples of the predetermined play condition include that the player has won a particular prize, that the player has won the jackpot, and that the player has played the game a predetermined number or more of times on the gaming machines 10. When there are too many players to give a bonus, the number of players to give a bonus is limited by imposing predetermined play conditions on the players.

The casino management server 20 publishes the current jackpot value through the Web service provided by the Web server 40 on the Internet N4, thereby attracting customers. In particular, the users of the communication terminals connected to the Internet N4 can confirm if the jackpot value is not more than the threshold and come to the shop to play on the gaming machines 10 when the jackpot value is not more than the threshold in order to get a bonus. In this case, the casino management server 20 indirectly sends the jackpot value to the users of the communication terminals.

The casino management server 20 can also send the jackpot value directly to the communication terminals T1 and T2 connected to the Internet N4, using the E-mail addresses in the database 21. In the case where the jackpot value is published through the Web service provided by the Web server 40, it can be checked by any number of unspecified people. In contrast, in the case where the casino management server 20 sends the jackpot value to the communication terminals T1 and T2, the destinations (i.e., notification destinations) of the jackpot value can be limited as appropriate.

At this time, bonus processing may be conducted using the identification information of the users of the communication terminals to which the casino management server 20 has sent the jackpot value. Determination of the user of the communication terminal to which the casino management server 20 has sent the jackpot value can be done by referring to the customer ID associated with the E-mail address to which the jackpot value has been sent.

The casino management server 20 may decrease the number of communication terminals to which the jackpot value is sent, as the jackpot value increases. For instance, when the jackpot value is not more than the threshold, the jackpot value is sent to the communication terminals of all members (i.e., the communication terminals of regular members and VIP members). Meanwhile, when the jackpot value exceeds the threshold, the jackpot value is only sent to the communication terminals of VIP members. Since the jackpot winning rate rises with an increase in jackpot value as described above, information that the jackpot value is high is useful information and thus is notified only to VIP members.

The casino management server 20 may conduct the aforementioned bonus processing if the progressive jackpot value during the play with the gaming machine 10 is within a predetermined range, and also if the player on the gaming machine 10 has reached a predetermined game score with the external service, the player on the gaming machine 10 uses the external service with a frequency at or above a predetermined level, and the player on the gaming machine 10 has confirmed the jackpot value with the external service during a past predetermined period, for example.

The predetermined bonus may be a bonus available in the external service. For instance, the player on the gaming machine 10 may be granted items or points available in the external service or the right to use the external service for free for a predetermined period.

It should be noted that the function of the casino management server 20 can also be achieved by executing a program with a computer.

In particular, a program can be constructed which instructs at least one computer to function in the same manner as the casino management server 20. The function achieved by executing such a program is similar to the casino management server 20, specifically, receives the jackpot value under control of the jackpot controller 30 and, if the received jackpot value is within a predetermined range, conducts bonus processing for a predetermined bonus by using the identification information of the player on the gaming machine 10.

The program may be provided being stored in a non-transitory recording medium such as ROM, a semiconductor memory, or any other recording medium that can be read by a computer.

The present disclosure should not be limited to the above embodiment and can be implemented in an appropriate embodiment.

For example, the casino management server 20 should not necessarily be installed in the casino. It is sometimes preferable to manage a plurality of casinos run by the same operator with one casino management server 20. In this case, the casino management server 20 is installed in not in the other casinos but in only one casino. Alternatively, the casino management server 20 is not installed in any of these casinos.

For another example, the jackpot value in the jackpot controller 30 should not necessarily be sent to the casino management server 20 via the gaming machine 10, but may be directly sent to the casino management server 20 through a communication line (dashed line L in FIG. 1) provided as appropriate to connect the jackpot controller 30 to the casino management server 20.

For another example, the above embodiment takes a management system for casinos as an example, although this is not necessarily the case. The management system can also be used in game arcades for gaming machines, e.g., medal game machines, which involve a medal betting operation, and arcade game machines, which involve an operation for betting points available in the game. The configuration and process flow of such a system, which are similar to those of the casino management system illustrated in FIGS. 1 and 4, can be changed as appropriate. For instance, the jackpot controller and the management server may be achieved by a common hardware.

For another example, the above embodiment takes a case where the right to receive a bonus is given according to the jackpot value at the start of the game or the winning of the jackpot as an example, although this is not necessarily the case. The right to receive a bonus may be given, for example, according to the jackpot value at the time when the total amount of bet reaches a predetermined value or more after the start of the game or according to the jackpot value after a predetermined period or more after the start of the game. Bonus processing may be conducted according to the jackpot value at the time when a predetermined game condition is satisfied on the gaming machine (e.g., at the time when a predetermined prize is won on a slot gaming machine) as well as at the winning of the jackpot.

A management system according to one aspect of the present disclosure comprises: at least one gaming machine, a jackpot controller that increases the progressive jackpot value according to a betting operation by the player on the at least one gaming machine and determines the winner of the progressive jackpot for the at least one gaming machine; and a management device that is communicably connected to the at least one gaming machine with each other and conducts bonus processing for predetermined bonus by using the identification information of the player on the gaming machine of the at least one gaming machine based on at least the progressive jackpot value being within a predetermined range. Examples of managing system include, but are not limited to, the management system 1 in FIG. 1. Examples of gaming machine include, but are not limited to, the gaming machine 10 in FIG. 1. Examples of jackpot controller include, but are not limited to, the jackpot controller 30. Examples of management device include, but are not limited to, the casino management server 20 in FIG. 1.

A management device according to one aspect of the present disclosure comprises: a receiver that receives a progressive jackpot value increasing according to a betting operation by the player on the at least one gaming machine and being controlled by a jackpot controller; and a bonus processor that conducts bonus processing for a predetermined bonus by using the identification information of the player on the gaming machine of the at least one gaming machine based on at least the progressive jackpot value being within a predetermined range. Examples of receiver include, but are not limited to, the receiver 22 in FIG. 2. Examples of bonus processor include, but are not limited to, the bonus processor 23 in FIG. 2.

A non-transitory recording medium storing a program according to one aspect of the present disclosure makes a computer function as: a receiver receiving a progressive jackpot value increasing according to a betting operation by a player on at least one gaming machine and being controlled by a jackpot controller; and a bonus processor conducting bonus processing for a predetermined bonus by using the identification information of a player on the gaming machine of the at least one gaming machine based on at least the progressive jackpot value being within a predetermined range.

In one embodiment, in the management device, the bonus processing is conducted based on the jackpot value being within the predetermined range, that is, not more than a predetermined threshold. At a jackpot value not more than the threshold, which indicates a low operating rate of the gaming machines, granting the players on the gaming machines 10 the right to receive a predetermined bonus is effective in motivating the guests to play on the gaming machines 10.

In one embodiment, the management device may store grouping information used to classify players into a plurality of groups and may set different thresholds for different groups of players according to the grouping information.

In one embodiment, the management device is connected to an external network excluding the gaming machine 10 and can send information on the progressive jackpot value directly or indirectly to communication terminals connected to the external network. Examples of external network include, but are not limited to, the Internet N4. Examples of communication terminal include, but are not limited to, the communication terminal T1 and T2.

In one embodiment, the management device sends information on the progressive jackpot value to the communication terminals of predetermined users.

In one embodiment, if the player on the gaming machine is the user of any communication terminal to which the information on the progressive jackpot value has been sent, the management device conducts bonus processing for a predetermined bonus by using the identification information of the user.

In one embodiment, the management device decreases the number of communication terminals to which information on the progressive jackpot value is sent, as the progressive jackpot value increases. Since the jackpot winning rate increases with an increase in progressive jackpot value, information that the progressive jackpot value is high is useful information which should preferably be published to limited guests such as VIP members.

In one embodiment, the management device conducts bonus processing if the progressive jackpot value is within a predetermined range and a predetermined play condition related to the player on the gaming machine is satisfied.

In one embodiment, the predetermined play condition is that the player has started a game on the gaming machine, that the player has played the game on the gaming machine over a predetermined period from the start of the game, that the player has won a particular prize on the gaming machine, that the player has won the progressive jackpot on the gaming machine, or that the total amount of bet has reached a predetermined value or more after the player starts the game on the gaming machine.

In one embodiment, as the bonus processing, the management device stores information on the right to receive the bonus in association with the identification information of the player.

One embodiment further comprises an accounting device which performs an accounting operation for services provided to the customers. This accounting device performs an accounting operation based on information on the right to receive the bonus, for a customer who is a player whose identification information is associated with the information on the right to receive the bonus. Examples of accounting device include, but are not limited to, the accounting device 27 in FIG. 1.

One embodiment further comprises a request-for-service reception device that receives requests for services from customers. The request-for-service reception device performs a receiving operation based on information on the right to receive the bonus, for a customer who is the player whose identification information is associated with the information on the right to receive the bonus. Examples of request-for-service reception device include, but are not limited to, the request-for-service reception device 28 in FIG. 1

What is claimed is:

1. A management system comprising:
at least one gaming machine;
a jackpot controller that increases a progressive jackpot value according to a betting operation by a player on the at least one gaming machine and determines a winner of a progressive jackpot for the at least one gaming machine; and
a management device that is communicably connected to the at least one gaming machine with each other and conducts bonus processing for a predetermined bonus by using identification information of the player on the gaming machine of the at least one gaming machine based on at least the progressive jackpot value being within a predetermined range.

2. The management system according to claim 1, wherein in the management device, the bonus processing is conducted based on the progressive jackpot value being within the predetermined range, that is, not more than a predetermined threshold.

3. The management system according to claim 2, wherein the management device stores grouping information used to classify players into a plurality of groups and set different thresholds for different groups of players according to the grouping information.

4. The management system according to claim 1, wherein the management device is connected to an external network excluding the gaming machine and sends information on the progressive jackpot value directly or indirectly to a communication terminal connected to the external network.

5. The management system according to claim 4, wherein the management device sends information on the progressive jackpot value to the communication terminal of a predetermined user.

6. The management system according to claim 5, wherein based on the player on the gaming machine being the user of the communication terminal to which the information on the progressive jackpot value has been sent, the management device conducts the bonus processing by using the identification information of the user.

7. The management system according to claim 5, wherein the management device decreases the number of communication terminals to which information on the progressive jackpot value is sent, as the progressive jackpot value increases.

8. The management system according to claim 1, wherein the management device conducts the bonus processing if the progressive jackpot value is within a predetermined range and a predetermined play condition related to the player on the gaming machine is satisfied.

9. The management system according to claim 8, wherein the predetermined play condition is that the player has started a game on the gaming machine, that the player has played the game on the gaming machine over a predetermined period from the start of the game, that the player has won a particular prize on the gaming machine, that the player has won the progressive jackpot on the gaming machine, or that the player has placed a predetermined amount or more of bet after the start of the game on the gaming machine.

10. The management system according to claim 1, wherein, as the bonus processing, the management device stores information on a right to receive the bonus in association with the identification information of the player.

11. The management system according to claim 10, further comprising an accounting device which performs an accounting operation for services provided to customers, wherein the accounting device performs an accounting operation based on information on the right to receive the bonus, for a customer who is a player whose identification information is stored in association with the information on the right to receive the bonus.

12. The management system according to claim 10, further comprising a request-for-service reception device that receives requests for services from customers, wherein the request-for-service reception device performs a receiving operation based on information on the right to receive the bonus, for a customer who is the player whose identification information is stored in association with the information on the right to receive the bonus.

13. A management device comprising:
a receiver receiving a progressive jackpot value increasing according to a betting operation by a player on at least one gaming machine and being controlled by a jackpot controller; and
a bonus processor conducting bonus processing for a predetermined bonus by using identification information of the player on the gaming machine of the at least one gaming machine based on at least the progressive jackpot value being within a predetermined range.

14. The management device according to claim 13, wherein, as the bonus processing, the bonus processor stores information on a right to receive a bonus in association with the identification information of the player.

15. A non-transitory recording medium storing a computer program for making a computer function as:
a receiver receiving a progressive jackpot value increasing according to a betting operation by a player on at least one gaming machine and being controlled by a jackpot controller; and
a bonus processor conducting bonus processing for a predetermined bonus by using identification information of a player on the gaming machine of the at least one gaming machine based on at least the progressive jackpot value being within a predetermined range.

16. The non-transitory recording medium according to claim 15, wherein, as the bonus processing, the bonus processor stores information on a right to receive the bonus in association with the identification information of the player.
